(19) United States
(12) Patent Application Publication
(10) Pub. No.: US 2005/0216728 A1
(43) Pub. Date: Sep. 29, 2005

(54) Integration of credit card into mobile terminal

(76) Inventors: Sandeep Relan, Bangalore (IN); Brajabandhu Mishra, Bangalore (IN); Rajendra Khare, Bangalore (IN)

Correspondence Address: CHRISTOPHER C WINSLADE;MCANDREWS HELD & MALLOW LTD, 34TH FLOOR, 500 WEST MADISON STREET, CHICAGO, IL, 60661, US

(21) Appl. No.: 10/810,875

(22) Filed: Mar. 26, 2004

(51) Int. Cl. H04L 9/00

(52) U.S. Cl. 713/153

(57) ABSTRACT

Presented herein are systems and methods for integrating credit cards into mobile terminals. A mobile terminal comprises a secured non-volatile memory, a keypad, and an output. The non-volatile memory stores credit card account information. The keypad provides inputs. The output provides the credit card account information after the keypad provides a certain input.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Credit cards are an increasingly popular payment system for many transactions because they offer many advantages over cash. Among the many advantages include security, avoiding carrying large amounts of cash, an instant loan, and payment in transactions that are not face-to-face.

Many credit card vendors now offer instant approval for credit cards. For example, a customer can call the credit card vendor and provide information for an application over the phone. Alternatively, the user can provide the information to a web site operated by the vendor. The vendor can then take the information and make a decision whether or not to approve the customer's credit application. Upon approving the customer's credit application, the vendor then issues a credit card to the customer. The credit card is usually a plastic card that includes a magnetic strip. The magnetic strip electronically encodes information regarding the customer and their account with the vendor. During a transaction, a seller can accept payment using the credit card by reading the magnetic strip.

Although the customer can get instant approval for their credit card application, the customer must still wait to receive the credit card itself. The credit card is usually mailed, taking a few days for delivery. This can be an inconvenience where the customer is induced to apply for the credit card from a contemplated sale. Customers usually want to take immediate possession of the goods in the contemplated sale. However, waiting a few days for delivery delays the completion of the transaction.

The other disadvantages of the traditional approach are following. The credit card can get lost in the mail. The magnetic strip of the credit card can get damaged after prolonged use. In order to take advantages of credit cards from multiple vendors, one needs to carry multiple credit cards in one's wallet. Further, there can be theft of identity of the credit card account such as credit card number and can be used by unauthorized people for internet based transactions.

Further limitations and disadvantages of convention and traditional approaches will become apparent to one of ordinary skill in the art through comparison of such systems with the present invention as set forth in the remainder of the present application with reference to the drawings.

### BRIEF SUMMARY OF THE INVENTION

Presented herein are systems and methods for integrating credit cards into mobile terminals.

In one embodiment, there is presented a mobile terminal. The mobile terminal comprises a non-volatile memory, a keypad, and an output. The non-volatile memory stores credit card account information. The keypad provides inputs. The output provides the credit card account information after the keypad provides a certain input.

In another embodiment, there is presented a method for providing credit. The method comprises receiving an application for credit and an identifier identifying a mobile terminal; establishing a credit card account; and transmitting information about the credit card account to the mobile terminal identified by the identifier.

In another embodiment, there is presented a server for providing credit. The server comprises memory and a processor. The memory stores a plurality of executable instructions. The plurality of executable instructions are for receiving an application for credit and an identifier identifying a mobile terminal; establishing a credit card account; and transmitting information about the credit card account to the mobile terminal identified by the identifier. The processor executes the plurality of executable instructions.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram describing an exemplary mobile terminal in accordance with an embodiment of the present invention;

FIG. 2 is an exemplary communication system for configuring a mobile terminal with credit card account information;

FIG. 3 is a block diagram of an exemplary cellular radio network comprising a Global System for Mobile Communication Public Land Mobile Network that can be used in accordance with an embodiment of the present invention;

FIG. 4 is a signal flow diagram for configuring a mobile terminal to provide credit card account information with an embodiment of the present invention;

FIG. 5 is a signal flow diagram for configuring a mobile terminal to provide credit card account information in accordance with another embodiment of the present invention;

FIG. 6 is a signal flow diagram for configuring a mobile terminal to provide credit card account information in accordance with another embodiment of the present invention;

FIG. 7 is a block diagram of a cellular radio network comprising a GSM network with General Packet Radio Services (GPRS) functionality that can be used in accordance with an embodiment of the present invention;

FIG. 8 is a signal flow diagram for configuring a mobile terminal to provide credit card account information in accordance with another embodiment of the present invention; and

FIG. 9 is a flow diagram for configuring a mobile terminal to provide credit card account information in accordance with another embodiment of the present invention.

### DETAILED DESCRIPTION OF THE INVENTION

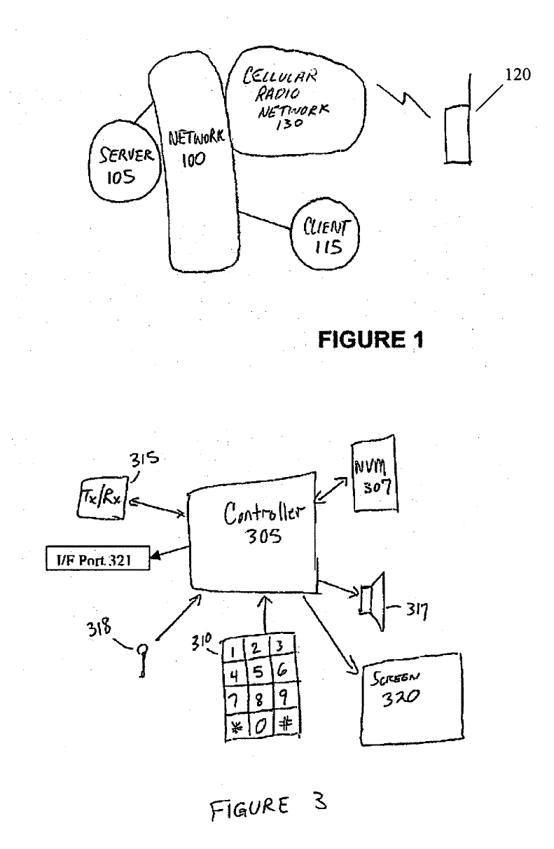

Referring now to FIG. 1, there is illustrated a block diagram of an exemplary communication system for configuring a mobile terminal to provide credit card account information in accordance with an embodiment of the present invention. The system includes a network 100 for communication between a server 105 and a client terminal 115, and a cellular radio network 130 for communication to a mobile terminal 120.

The server 105 may be capable to receive requisite information for an application for credit. For example, the server 105 can provide a graphical user interface for display on the client terminal 115 that guides the customer to provide the requisite information for the application for credit. Additionally, the server 105 may also be capable of rendering a decision to approve or reject the application for credit based on the information received. Additionally, the server 105 may also be capable of accessing information from other source via the computer network 100, such as credit bureau records and public data records.

The client terminal 115 can include a terminal capable of interacting with the server 105. For example, the client terminal 115 can include a computer equipped with a program for displaying a graphical user interface provided by the server 105 known as a browser.

The client terminal 115 can also include the mobile terminal 120. The mobile terminal 120 can interact with the server 105 in a number of ways. In one embodiment, the mobile terminal 120 can interact with the server 105 by establishing a phone call with the server 105, during which the customer provides the information for the application for credit.

In another embodiment, the mobile terminal 120 can interact with the server 105 via a wireless internet connection. The mobile terminal 120 can be equipped with a browser for displaying a graphical user interface provided by the server 105 on the mobile terminal 120, and providing user inputs from the mobile terminal 120 to the server 105.

The network 100 can comprise a variety of networks such as the internet, a local area network, a wide area network, a fiber optic network, or a public switched telephone network, or any combination of the foregoing. Additionally, in the case where the client terminal 115 is the mobile terminal 120, the network 100 comprises the cellular radio network 130 and can also comprise the internet or the public switched telephone network.

During the application for credit, the customer via the client terminal 115 provides the server 105 with an identifier that identifies a mobile terminal 120 associated with the customer. When the server 105 approves the customer's application for credit, the server 105 establishes a credit card account for the customer. The cellular radio network 130 then provides the credit card account information to the mobile terminal 120 associated with the customer, using the identifier identifying the mobile terminal 120.

The cellular radio network 130 can comprise a variety of wireless telecommunications networks, such as, but not limited to, the Global System for Mobile (GSM) Communications, or the Personal Communication Services (PCS) network, Code Division Multiple Access (CDMA) network, IEEE 802.11 Wireless LAN network, Bluetooth network etc.

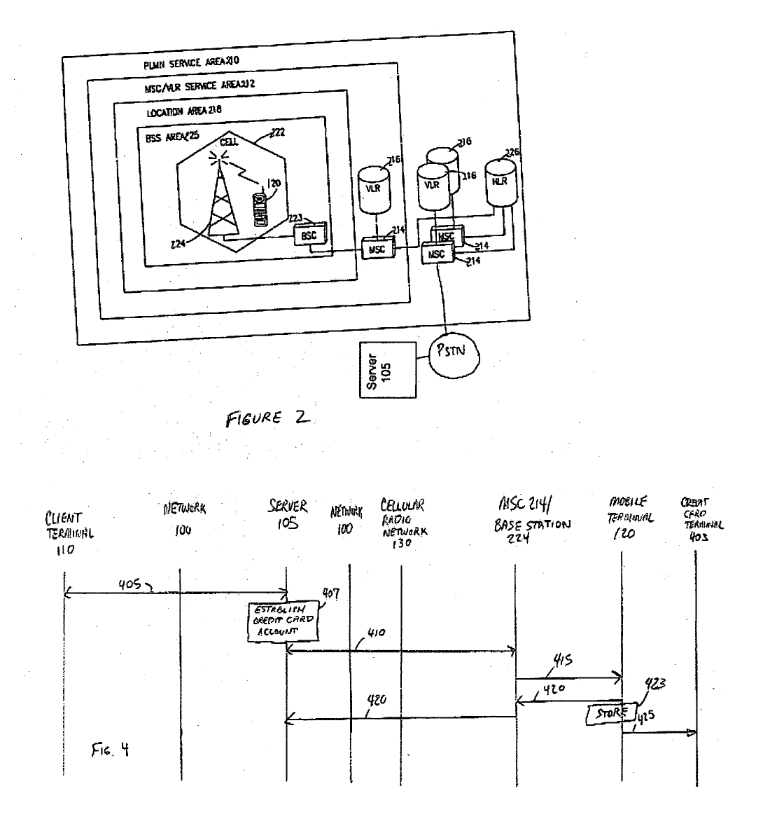

Referring now to FIG. 2 there is illustrated a block diagram of a Global System for Mobile Communication (GSM) Public Land Mobile Network (PLMN) 210. The PMLN 210 is composed of a plurality of areas 212, each with a node known as a Mobile Switching Center (MSC) 214 and an integrated Visitor Location Register (VLR) 216 therein. The MSC/VLR areas 212, in turn, include a plurality of Location Areas (LA) 218, which are defined as that part of a given MSC/VLR area 212 in which a mobile terminal 120 may move freely without having to send update location information to the MSC/VLR area 212 that controls the LA 218. Each Location Area 212 is divided into a number of cells 222. The mobile terminal 120 is the physical equipment, e.g., a car phone or other portable phone, used by mobile subscribers to communicate with the cellular network 210, each other, and users outside the subscribed network, both wireline and wireless.

The MSC 214 is in communication with at least one Base Station Controller (BSC) 223, which, in turn, is in contact with at least one Base Transceiver Station (BTS) 224. The BTS is a node comprising the physical equipment, illustrated for simplicity as a radio tower, that provides radio coverage to the geographical part of the cell 222 for which it is responsible. It should be understood that the BSC 223 may be connected to several base transceiver stations 224, and may be implemented as a stand-alone node or integrated with the MSC 214. In either event, the BSC 223 and BTS 224 components, as a whole, are generally referred to as a Base Station System (BSS) 225. At least one of the MSCs 214 are connected to the public switched telephone network (PSTN).

The PLMN Service Area or wireless network 210 includes a Home Location Register (HLR) 226, which is a database maintaining all subscriber information, e.g., user profiles, current location information, International Mobile Subscriber Identity (IMSI) numbers, and other administrative information. The HLR 226 may be co-located with a given MSC 214, integrated with the MSC 214, or alternatively can service multiple MSCs 214, the latter of which is illustrated in FIG. 2.

The VLR 216 is a database containing information about all of the mobile terminals 120 currently located within the MSC/VLR area 212. If a mobile terminal 120 roams into a new MSC/VLR area 212, the VLR 216 connected to that MSC 214 will request data about that mobile terminal 120 from the HLR database 226 (simultaneously informing the HLR 226 about the current location of the mobile terminal 120). Accordingly, if the user of the mobile terminal 120 then wants to make a call, the local VLR 216 will have the requisite identification information without having to re-interrogate the HLR 226. In the afore-described manner, the VLR and HLR databases 216 and 226, respectively, contain various subscriber information associated with a given mobile terminal 120.

In one embodiment, the server 105 can establish a phone call with the mobile terminal 120 over the GSM PLMN 210, either directly or via the PSTN. Upon establishing the phone call, the server 105 transmits audio signals to the mobile terminal 120 causing the mobile terminal 120 to store the credit card account information therein. Alternatively, the server 105 can cause one of the MSCs 214 to transmit a control signal, via a base station 224 to the mobile terminal 120, causing the mobile terminal 120 to store the credit card account information. These are few of the many possible techniques of transmitting the credit card account information to the mobile terminal 120.

Transmitting the credit card account information during an established call can be facilitated by the establishment of a predetermined communication protocol for secured communication between the server 105 and the mobile terminal 120. Such predetermined protocol can include transmission of an arbitrary control signal indicating to the mobile terminal 120 that the credit card account information will be transmitted subsequently. Upon receipt of the foregoing arbitrary control signal, the mobile terminal 120 prepares to receive and store the credit card account information. The communication between server 105 and mobile terminal 120 can be made secured by employing secured communication protocols such as but not limited to, the protocols using digital certificates like Transport Layer Security (TLS) protocol, Secure Socket Layer (SSL) protocol, and in “GPS Based Secure Access, App. Ser. No. ______ (Docket 15487US01), filed Mar. 24, 2004 by Relan, et. al. and incorporated herein by reference.

Transmitting a control signal from a particular one of the MSCs 214 to the mobile terminal 120 may be facilitated by adapting the preexisting protocol to define commands that cause the mobile terminal 120 to store the credit card account information. For example, the MSC 214 can transmit a command to store the credit card account information to the mobile terminal 120 over a paging channel. For added security, a secure paging channel can be used. Upon receiving the foregoing signal, the mobile terminal 120 stores the credit card account information. After storing the credit card account information, the mobile terminal 120 can transmit an acknowledgement to the MSC 214 using a random access channel. Further the credit card information can be made secured inside the mobile terminal 120 by employing various cryptographic techniques.

Referring now to FIG. 3, there is illustrated a block diagram describing an exemplary mobile terminal 120 in accordance with an embodiment of the present invention. For purposes of clarity, the block diagram is not intended as an exhaustive illustration, and certain components may be omitted.

The mobile terminal 120 comprises a controller 305, non-volatile memory 307, a keypad 310, a transceiver 315, a speaker 317, a microphone 318, a visual screen 320, and/or interface port 321. The non-volatile memory 307 stores credit card account information. The credit card information can be used to place charges on the credit card account. When the user wishes to place a charge on the credit card account, the user can cause the mobile terminal 120 to provide the credit card account information. In order to protect the credit card information from unauthorized users in case of theft or lose of the mobile terminal, the non-volatile memory needs to be made secured by employing various cryptographic techniques.

The user causes the mobile terminal 120 to provide the credit card account information by providing inputs via the keypad 310. In one embodiment, the controller 305 can provide a graphical user interface for the display on the visual screen 320. The graphical user interface can guide the user to select an appropriate combination of keys on the keypad 310. The selection of the combination of keys on the keypad 310 is input to the controller 305. Upon receipt of the input, the controller 305 causes the mobile terminal 120 to fetch the credit card information from the non-volatile memory 307. When the controller 305 fetches the credit card information from the non-volatile memory 307, then causes the mobile terminal 120 to provide the credit card information.

In one embodiment, the mobile terminal 120 can output the credit card account information via the interface port 321. The interface port 321 can be connectable to a credit card terminal. The credit card terminal is a terminal that is equipped to receive credit card information and facilitate placement of a charge to the credit card account. Alternatively, the interface port 321 can comprise an infrared transmitter and transmit the credit card account information using infrared signals. The credit card terminal can include an infrared receiver for receiving the infrared signals and facilitate placement of the charge. Further, the interface port 321 can comprise an a transmitter for any standard point to point communication protocol and transmit the credit card account information using that point to point communication protocol. The credit card terminal can include a receiver for that point to point communication protocol for receiving the infrared signals and facilitate placement of the charge.

In another embodiment, the mobile terminal 120 can provide the credit card information by transmitting a local radio signal via the transceiver 315. A credit card terminal appropriately equipped with a receiver can receive the local radio signal and facilitate placement of the charge.

The mobile terminal 120 receives the credit card information via radio signals provided by a cellular network and received by transceiver 315. The transceiver 315 can perform various demodulation, and signal processing to recover credit card account information. The controller 305 writes the credit card account information to the secured non-volatile memory 307.

The mobile terminal 120 generally operates in one of three modes—a paging mode, an active mode, and a data mode. Generally, the paging mode is associated with the times that the mobile terminal 120 is not engaged in a phone call, while the active mode is associated with the times that the mobile terminal 120 is engaged in a phone call. In data mode, the data related to the credit information is exchanged between the mobile terminal 120 and the credit card terminal.

During the paging mode, the mobile terminal 120 scans a paging channel at regular time intervals for any communications from the cellular network 130. The communications can include for example, a request for a phone connection, a request for user registration, a time indicator, quality of service signaling, and roaming notifications, just to name a few.

The paging channel is made secured by employing security protocols based on Public Key Cryptography technique. Examples of such protocols are TLS, SSL etc. These protocols exchange digital certificates for authentication, and at the end of the authentication process a unique session key is derived which is used to encrypt the credit card account information at the transmitter end and decrypt the credit card account information at the mobile terminal 120.

In one embodiment of the present invention, a command is defined and the cellular network transmits the command, and credit card information over the paging channel to the mobile terminal 120. Receipt of the command by the mobile terminal 120 causes the controller 305 to write the credit card account information to the non-volatile memory 307. Additionally, the mobile terminal 120 can transmit an acknowledgment via the transceiver 315.

Accordingly, the non-volatile memory 307 can include instructions for detecting and performing the foregoing actions responsive to receiving the command. The foregoing instructions can be incorporated as part of a paging mode program.

In another mode, receipt of the command by the mobile terminal 120 can cause an interrupt in the paging mode program. The interrupt handler for the interrupt can cause the controller 305 to write the credit card account information to the non-volatile memory 307.

In another embodiment, the mobile terminal 120 can receive the credit card account information during establishment of a phone call from the cellular network 130. A predetermined communication protocol for communication between the server 105 and the mobile terminal 120 can include transmission of an arbitrary control signal indicating to the mobile terminal 120 that the credit card account information will be transmitted subsequently. The non-volatile memory 307 can include instructions for detecting the arbitrary control signal and acting on the arbitrary control signal. Upon detecting the arbitrary control signal, the mobile terminal 120 prepares to receive the credit card account information. Upon receiving the information, the mobile terminal 120 stores the credit card account information.

In another embodiment, the non-volatile memory 307 can store a portable browser for displaying a graphical user interface from the server 105 on the visual screen 320. The graphical user interface can guide the customer to provide information for an application for credit to the server 105. Responsive thereto, the mobile terminal 120 can receive the credit card account information and a command to store the credit card account information in the form of data packets. The non-volatile memory 307 can include instructions for detecting and acting on the command.

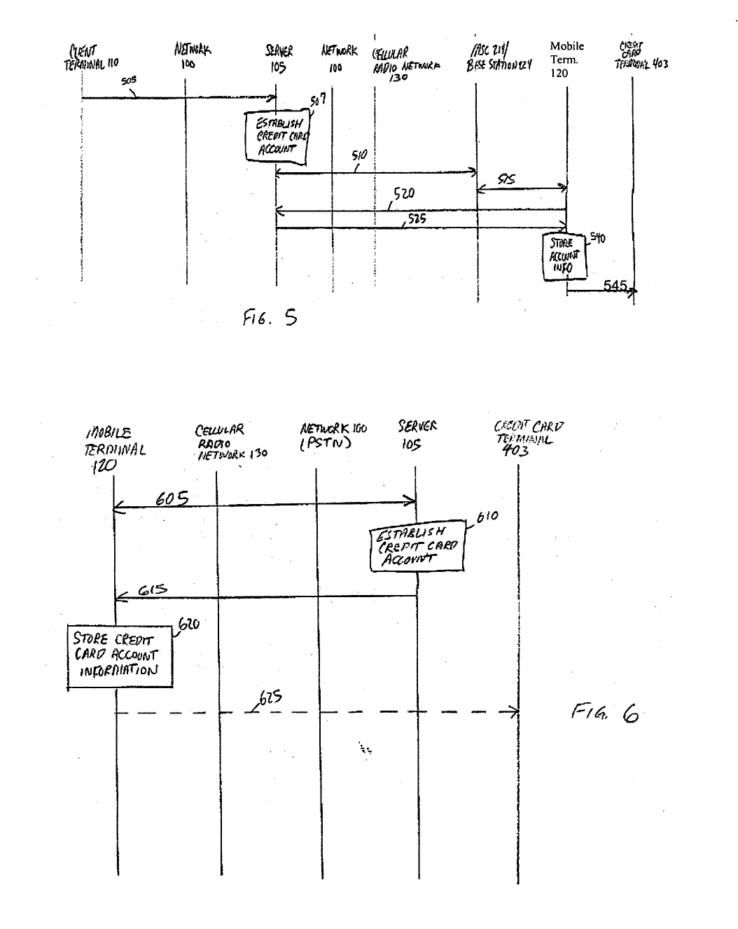

Referring now to FIG. 4, there is illustrated a signal flow diagram for providing the credit card account information in accordance with one embodiment of the present invention. Initially, the customer makes an application for credit using the client terminal 110 with the server 105 associated with credit card vendor (signal 405). During the application for credit, the server 105 receives the phone number or other identifier that identifies the mobile terminal 120. Responsive thereto, the server 105 establishes (407) a credit card account for the user.

The server 105 transmits the credit card account information (signal 410) over the cellular radio network 130. The infrastructure of the cellular phone network 130 identifies and locates the mobile terminal 120 associated with the phone number or identifier identifying the mobile terminal 120, and routes the credit card account information to an MSC 214 in proximity to the mobile terminal 214. The MSC 214 causes a base station to transmit the credit card account information and a command to load the credit card account information (signal 415) to the mobile terminal 120 using a paging channel.

Upon receipt of the credit card account information and the synchronization time, the mobile terminal 120 sends an acknowledgement (signal 420) to the MSC 214 using a random access channel, that is relayed back to the server 105, and stores (423) the credit card account information.

The customer can then use the mobile terminal 120 to place charges on their credit card account. The customer can place a charge on their account by taking the mobile terminal 120 to a credit card terminal 403. At the credit card terminal 403, the customer can use the keypad to command the mobile terminal 120 to provide the credit card account information (signal 425) to the credit card terminal 403. The credit card terminal 403 can then electronically transmit the information to the credit card vendor.

Referring now to FIG. 5, there is illustrated a signal flow diagram for providing credit card account information to a mobile terminal 120 in accordance with one embodiment of the present invention. Initially, the customer makes an application (signal 505) for credit using the client terminal 110 via network to the server 105 (signal 505). During the application for credit, the server 105 receives the phone number or other identifier identifying mobile terminal 120. Responsive thereto, the server 105 establishes (507) a credit card account.

The server 105 requests an outgoing phone call (signal 510) to the mobile terminal 120 identified during the application for credit. The infrastructure of the cellular radio network 130 identifies and locates the identified mobile terminal 120. An MSC 214 in proximity to the mobile terminal 120 pages (signal 515) the mobile terminal 120 using a paging channel.

Upon receiving the page, the mobile terminal 120 alerts the user to answer the call. Upon the user's answer, a phone call (520) is established between the server 105 and the mobile terminal 120. The server 105 transmits audio signals indicating a command (signal 525) to store the credit card account information (540).

The mobile terminal 120 stores (540) the credit card account information in the non-volatile memory 307. The customer can then use the mobile terminal 120 to place charges on their credit card account. The customer can place a charge on their account by taking the mobile terminal 120 to a credit card terminal 403. At the credit card terminal 403, the customer can use the keypad to command the mobile terminal 120 to provide the credit card account information (signal 545) to the credit card terminal 403. The credit card terminal 403 can then electronically transmit the information to the credit card vendor.

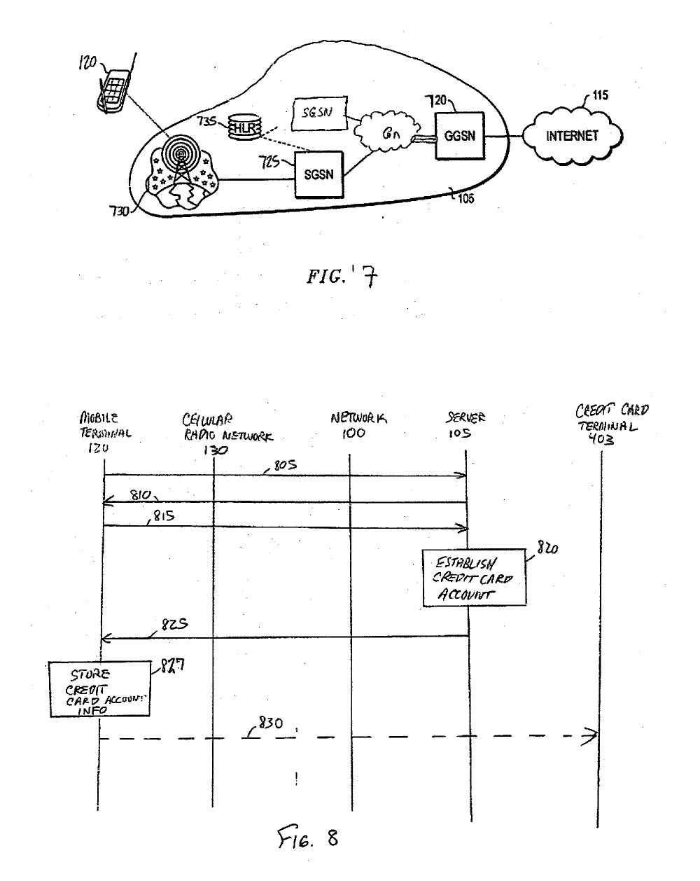

Referring now to FIG. 6, there is illustrated a signal flow diagram for providing credit card account information to the mobile terminal 120 in accordance with another embodiment of the present invention. The mobile terminal 120 can be used as the client terminal 110. The mobile terminal 120 can interact with the server 105 by establishing a phone call (signal 605) via the cellular radio network 130. The cellular radio network 130 on conjunction with the public switched telephone network (PSTN) route the phone call to the server 105.

During the phone call, the customer can provide information for an application for credit. Where the server 105 approves the application for credit card, the server 105 establishes (610) a credit card account for the customer. The server 105 can then transmit (615) audible signals corresponding to the credit card account information and a command to store the credit card account information to the mobile terminal 120. Upon receiving the credit card account information, the mobile terminal 120 stores (620) the credit card account information in the non-volatile memory 307.

The customer can place a charge on their account by taking the mobile terminal 120 to a credit card terminal 403. At the credit card terminal 403, the customer can use the keypad to command the mobile terminal 120 to provide the credit card account information (signal 625) to the credit card terminal 403. The credit card terminal 403 can then electronically transmit the information to the credit card vendor.

Alternatively, the mobile terminal 120 can access the server 105 using a data connection. Many cellular radio networks include both cellular phone as well as data services. For example, many GSM networks use General Packet Radio Services (GPRS) to provide data services as well. With a wireless web browser on the mobile terminal 120, the customers can wirelessly access the internet and web sites. In one embodiment of the present invention, the customer can use the mobile terminal 120 to access the server 105 using data services.

Referring now to FIG. 7, there is illustrated a signal flow diagram describing an exemplary cellular radio network comprising a GSM network with GPRS functionality. The cellular radio network 130 is interface with a wired network, such as the internet by any number of Gateway GPRS Support Nodes (GGSN) 720. Each GGSN 720 is associated with any number of Internet Protocol (IP) addresses, and in turn allocates the IP addresses to wireless terminals 120, either dynamically or statically. The internet uses IP addresses for addressing packets. The GGSN 720 includes registers that correlate IP addresses to mobile terminal identifiers, and uses the correlated mobile terminal identifier to route packets to the appropriate mobile terminal 120.

The cellular radio network 130 provides packet data services to geographical areas that are divided into routing areas. Each routing area is associated with a particular Serving GPRS Support Node (SGSN) 725. Each SGSN 725 is associated with any number of base station systems 730. The base station system 730 comprises the radio transceiver equipment that transmits and receives signals to and from the mobile terminal 120. Base station systems 730 maintain radio frequency communications within a geographic area known as a cell. The SGSN 725 uses a home location register (HLR) 735 to determine the location of the mobile terminal 120 and the appropriate base station 730.

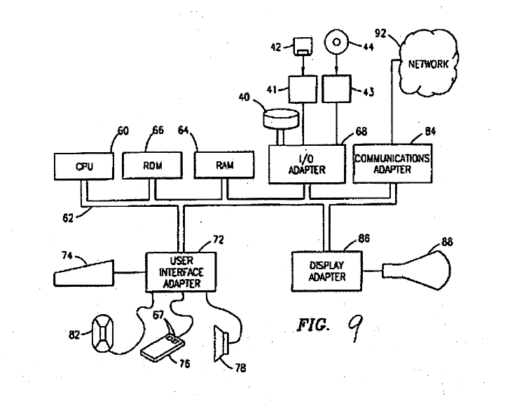

Referring now to FIG. 8, there is illustrated a signal flow diagram for providing credit card account information to a mobile terminal in accordance with another embodiment of the present invention. A customer with a mobile terminal 120 having pre-established wireless internet session with via the cellular radio network 130 and an associated IP address provides an identifier (such as but not limited to a web address) associated with the credit card vendor to a portable browser in the mobile terminal 120.

Responsive thereto, the mobile terminal 120 provides the identifier and its allocated IP address to the cellular radio network 130 via a base station. The cellular radio network 130 routes the foregoing to the network 100. The network 100 uses the identifier and polls the server 105 (signal 805). Responsive thereto, the server 105 sends (signal 810) a graphical user interface addressed to the IP address associated with the mobile terminal 120. The network 100 routes the graphical user interface to the cellular radio network 130 via GGSN. The GGSN determines the mobile terminal 120 associated with the IP address. The cellular radio network 130 then routes the graphical user interface to the mobile terminal 120.

The graphical user interface guides the customer to provide information to make an application for credit (signal 815). The cellular radio network 130 and network 100 then route the information for the application for credit to the server 105 as described above.

The server 105 can then approve or reject the application for credit. Where the server 105 approves the application for credit, the server 105 establishes (820) a credit card account for the customer.

Additionally, during the application for credit, the server 105 also receives an IP address associated with the mobile terminal 120. Upon establishing the credit card account, the server 105 transmits (signal 825) credit card account information and a command to store the credit card account information to the IP address associated with the mobile terminal 120. The network 110 and the cellular radio network 130 together route the information to the mobile terminal 120.

When the mobile terminal 120 receives the credit card account information and the command to store the credit card account information, the mobile terminal 120 stores (827) the credit card account information in the non-volatile memory 307.

The customer can place a charge on their account by taking the mobile terminal 120 to a credit card terminal 403. At the credit card terminal 403, the customer can use the keypad to command the mobile terminal 120 to provide the credit card account information (signal 830) to the credit card terminal 403. The credit card terminal 403 can then electronically transmit the information to the credit card vendor.

In another embodiment, the customer could be shopping over internet. In that case the customer will simply put the identifier or the phone number of the mobile terminal 120 in the web to inform it to the credit card terminal. Then the credit card terminal will dial the mobile terminal for authentication. If authentication succeeds, then the shopping charge is charged to the credit card account by the credit card terminal.

Referring now to FIG. 9, there is illustrated a block diagram of an exemplary server 105 in accordance with an embodiment of the present invention. A CPU 60 is interconnected via system bus 62 to random access memory (RAM) 64, read only memory (ROM) 66, an input/output (I/O) adapter 68, a user interface adapter 72, a communications adapter 84, and a display adapter 86. The input/output (I/O) adapter 68 connects peripheral devices such as hard disc drives 40, floppy disc drives 41 for reading removable floppy discs 42, and optical disc drives 43 for reading removable optical disc 44 (such as a compact disc or a digital versatile disc) to the system bus 62. The user interface adapter 72 connects devices such as a keyboard 74, a mouse 76 having a plurality of buttons 67, a speaker 78, a microphone 82, and/or other user interfaces devices such as a touch screen device (not shown) to the bus 62. The communications adapter 84 connects the computer system to a data processing network 92. The display adapter 86 connects a monitor 88 to the bus 62.

An embodiment of the present invention can be implemented as sets of instructions resident in the random access memory 64 of one or more systems configured generally as described in FIG. 9. Until required by the computer system 58, the set of instructions may be stored in another computer readable memory, for example in a hard disc drive 40, or in removable memory such as an optical disc 44 for eventual use in an optical disc drive 43, or a floppy disc 42 for eventual use in a floppy disc drive 41. The physical storage of the sets of instructions physically changes the medium upon which it is stored electrically, magnetically, or chemically so that the medium carries computer readable information.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A mobile terminal comprising:
a non-volatile memory for storing information for one or more accounts;
a control panel for providing inputs;
an output for providing the account information after the control panel provides a certain input.

2. The mobile terminal of claim 1, wherein the output comprises a transceiver.

3. The mobile terminal of claim 1, wherein the information stored in the non-volatile memory is encrypted.

4. The mobile terminal of claim 1, wherein the output comprises an interface port.

5. The mobile terminal of claim 4, wherein the interface port comprises an infra-red signal transmitter.

6. The mobile terminal of claim 4, wherein the interface port comprises a transmitter for any standard point-to-point communication protocol.

7. The mobile terminal of claim 1 further comprises wherein the non-volatile memory stores a plurality of instructions, said plurality of instructions for:
receiving a command and the information for the one or more accounts; and
storing the information for the one or more accounts after receiving the command; and
wherein the mobile terminal further comprises a controller for executing the instructions.

8. The mobile terminal of claim 7, wherein the command and the information for the one or more accounts are received during a phone call.

9. The mobile terminal of claim 7, wherein the command and the information for the one or more accounts is received over a paging channel.

10. The mobile terminal of claim 9, wherein the paging channel is a secure paging channel.

11. The mobile terminal of claim 1, wherein the mobile terminal is operable to provide the information about the one or more accounts, responsive to a request over a secure paging channel.

12. A method for providing credit, said method comprising:
receiving an application for an account and an identifier identifying a mobile terminal;
establishing an account; and
transmitting information about the account to the mobile terminal identified by the identifier.

13. The method of claim 12, wherein the identifier comprises a phone number.

14. The method of claim 12, wherein the identifier comprises a MAC address.

15. The method of claim 12, wherein transmitting the information about the account to the mobile terminal comprises:
placing an outgoing phone call to the mobile terminal.

16. The method of claim 12, wherein transmitting the information about the account to the mobile terminal comprises:
transmitting the information about the credit card account over a paging channel.

17. The method of claim 16, wherein the paging channel is a secure paging channel.

18. The method of claim 17, wherein the paging channel is secured with Public Key Cryptography.

19. The method of claim 12, wherein the identifier comprises a packet network address.

20. The method of claim 19, wherein transmitting the information about the account further comprises:
addressing the information about the account to the packet network address.

21. The method of claim 20, further comprising:
transmitting a graphical user interface for display on the mobile terminal.

22. The method of claim 12, wherein the said method also comprises of storing transaction history and account status.

23. A server for providing credit, said server comprising:
memory for storing a plurality of executable instructions, said plurality of executable instructions for:
receiving an application for an account and an identifier identifying a mobile terminal;
establishing an account; and
transmitting information about the account to the mobile terminal identified by the identifier; and
a processor for executing the plurality of executable instructions.

24. The server of claim 23, wherein the identifier comprises a phone number.

25. The server of claim 23, wherein the identifier comprises a MAC address.

26. The server of claim 23, wherein the identifier comprises a packet network address.

27. The server of claim 23, wherein transmitting the information about the account to the mobile terminal comprises:
placing an outgoing phone call to the mobile terminal.

28. The server of claim 23, wherein the identifier comprises a packet network address, and wherein transmitting the information about the credit card account further comprises:
addressing the information about the credit card account to the packet network address.

29. The server of claim 23, wherein the plurality of instructions define a graphical user interface for display on the mobile terminal.
